(19) United States
(12) Patent Application Publication
(10) Pub. No.: US 2024/0169020 A1
(43) Pub. Date: May 23, 2024

(54) WIND FIELD INTERPOLATION SIMULATION METHOD BASED ON ISOGEOMETRIC SAMPLING

(71) Applicant: DALIAN UNIVERSITY OF TECHNOLOGY, Dalian (CN)

(72) Inventors: Xing FU, Dalian (CN); Xingheng ZHANG, Dalian (CN); Hongnan LI, Dalian (CN); Gang LI, Dalian (CN); Shi GAN, Dalian (CN); Wenlong DU, Dalian (CN)

(21) Appl. No.: 18/025,235

(22) PCT Filed: Jun. 10, 2022
(86) PCT No.: PCT/CN2022/098012

§ 371 Date: Mar. 8, 2023

(51) Int. Cl. G06F 17/16; G06F 30/20; G06F 111/10

(52) U.S. Cl. CPC G06F 17/16; G06F 30/20; G06F 2111/10

(57) ABSTRACT

A wind field interpolation simulation method based on isogeometric sampling, the main steps of generating a wind speed time series in the present invention are as follows: first, inputting basic parameters of wind field simulation and the number of initial sampling points, and selecting the sampling points by an isogeometric sampling method. Then calculating the maximum relative error of all frequency bands by a relative error defined, and judging a fitting error and an allowable error given. If the fitting error is greater than the allowable error, increasing the number of sampling points and reselecting the sampling points; if the fitting error is less than or equal to the allowable error, finishing point selection, and using an interpolation function to calculate a lower triangular matrix required by the simulation. Thus a fluctuating wind field can be generated by a harmonic superposition method.

### TECHNICAL FIELD

The present invention belongs to the technical field of structural wind engineering, and particularly relates to a numerical simulation method for generating a wind speed time series.

### BACKGROUND

Economic losses caused by wind disaster exceed those caused by earthquake, fire, flood and other natural disasters, so wind disaster is one of the most serious disasters that cause human and property losses among natural disasters. Wind load is an important load in the design of a large structure, and even plays a decisive role. Wind tunnel tests, numerical simulation and field measurement are the main methods for the existing wind-resistance design. As an important supplement to the test, numerical simulation has the advantages of convenient operation and strong repeatability, which is suitable for wind load verification and design calculation.

A fluctuating wind load acting on a structure has significant dynamic characteristics and spatial-temporal distribution characteristics, which can be described by a spatial-temporal random field. In wind-resistance analysis of the structure, fluctuating wind is usually considered as a multi-dimensional, multi-variable, and ergodic stationary Gaussian process. The fluctuating wind speed time series at each point must satisfy certain statistical characteristics such as power spectral density and dependency relation. The harmonic superposition method is one of the most widely used methods for wind field simulation because of its clear theory and high accuracy. The idea of the harmonic superposition method is to superpose a series of trigonometric functions with random amplitudes or random frequencies to simulate a random process with specific statistical characteristics. A cross-spectral density matrix is used to consider the dependency among different variables in a multi-dimensional or multi-variable random process. In the process of wind speed simulation, Cholesky decomposition is required for the cross-spectral density matrix of the simulation points at each frequency point, so as to obtain a lower triangular matrix required for wind field simulation. When the number of simulation points is relatively large, Cholesky decomposition needs to be performed on a large number of cross-spectral density matrices, which greatly reduces the computational efficiency. Some scholars have used an interpolation function to calculate the required lower triangular matrix approximately, so as to reduce the number of times of matrix decomposition and improve the simulation efficiency. Researchers have noticed that a spectral matrix and a lower triangular matrix obtained by decomposition thereof change sharply in the low-frequency band, and change relatively gently in the high-frequency band, so the distribution of interpolation points needs to meet the requirements of “Dense in the low-frequency band and sparse in the high-frequency band”. However, with different power spectral selections, the obtained spectral matrices and lower triangular matrices obtained by decomposition thereof will be different, and therefore, the differences in the selection of interpolation points by different power spectral functions cannot be identified by only meeting the qualitative requirements of “Dense in the low-frequency band and sparse in the high-frequency band”.

Aiming at the lack of research on the distribution selection principle of frequency interpolation points, the present invention proposes a wind field interpolation simulation method based on isogeometric sampling, the core of which is to select appropriate positions and number of interpolation points by an isogeometric sampling method according to the function characteristics of a lower triangular matrix obtained by decomposing a cross-spectral density matrix, and which can adapt to different requirements of fluctuating wind power spectral density at different conditions.

### SUMMARY

The present invention proposes a wind field interpolation simulation method based on isogeometric sampling for wind load simulation of a large structure, and provides an efficient calculation method for the design and safety assessment of a large structure subjected to wind load.

The technical solution of the present invention is as follows:

A wind field interpolation simulation method based on isogeometric sampling, comprising the following steps:
(1) Taking the arithmetic square root \sqrt{S(n)} of a power spectral function at the middle height of all simulation points as an objective function R(n) for fitting, i.e., R(n)=\sqrt{S(n)}, selecting relevant geometric quantities such as an arc length and a curvature as a characteristic function λ(n) for sampling point selection according to the objective function, comprehensively considering the influence of the curvature and the arc length on shape, and defining the characteristic function λ(n) of R(n) as:

$$λ ( n ) = ( 1 - μ ) \frac{L ( n )}{L ( {n}_{b} )} + μ \frac{K ( n )}{K ( {n}_{b} )} , x ∈ [ {n}_{a} , {n}_{b} ] \qquad ( 1 )$$

where, n is a frequency, satisfying n∈[nₐ, n_{b}], nₐ and n_{b} are respectively the left and right endpoints of the definition domain of the objective function R(n), i.e., the starting and ending frequencies of the target power spectral density for wind field simulation; μ is a real number between 0 and 1, which is adjusted according to the calculation result; L(n) and K (n) are respectively the arc length and total curvature from R(nₐ) to R(n), wherein

$$\begin{matrix}L ( n ) = {\int }_{{n}_{a}}^{n} \sqrt{1 + {( R ' ( u ) )}^{2}} du , & K ( n ) =\end{matrix} {\int }_{{n}_{a}}^{n} \frac{\vert R \text{''} ( u ) \vert}{{( 1 + {( R ' ( u ) )}^{2} )}^{\frac{3}{2}}} du ;$$

integrands of both integrals are greater than or equal to 0 and are not always 0, λ(n) is strictly monotonically increasing, λ(nₐ)=0, and λ(n_{b})=1;
(2) Inputting the number of sampling points k₁, with the left and right endpoints removed from k₁; based on the characteristic function λ(n), selecting a frequency interpolation point nᵢ(1=1, 2, . . . , k₁), applying the frequency interpolation point to a double-indexing frequency simulation formula proposed by Deodatis, and calculating all λ(lΔn) according to a definite integral, wherein l can be 2, 3, 4, . . . , N−1; obtaining the lᵢ^{th} frequency, i.e., obtaining the frequency nₖₗ, of a double-indexing interpolation point, as shown in formulae (2) to (3):

$${l}_{i} = arg min \{ λ ( l Δ n ) - \frac{i}{{k}_{1} + 1} \} \qquad ( 2 )$$

$${n}_{{kl}_{i}} = ( {l}_{i} - 1 + \frac{k}{m} ) Δ n \qquad ( 3 )$$

where, arg min(⋅) is the value of the independent variable when the minimum value of “⋅” is taken, i.e., the value of l; m is the number of simulation points in a wind field,

$$Δ n = \frac{{n}_{u}}{N} , {n}_{u}$$

is the ending frequency of simulation, and N is a frequency isodisperse;
(3) Selecting the form of an interpolation function used for wind field simulation, and measuring the simulation accuracy of a target curve in the form of a relative error, so as to estimate a wind field simulation error; defining a relative error of the interpolation function in the i^{th} band, as shown in formula (4):

$$err ( i ) = max \{ max \{ \frac{\vert {R}_{1} ( n ) - {\hat{R}}_{1} ( n ) \vert}{{R}_{1} ( n )} \} , max \{ \frac{\vert {R}_{2} ( n ) - {\hat{R}}_{2} ( n ) \vert}{{R}_{2} ( n )} \} \} ( {n}_{i} \leq n < {n}_{i + 1} )$$

where, R₁(n) and R₂(n) respectively represent the arithmetic square roots of the power spectral function at the lowest and highest positions of all simulation points, \hat{R}₁(n) and \hat{R}₂(n) are respectively fitting functions of R₁(n) and R₂(n), and i=1, 2, . . . , k₁;
Recording the maximum value of vector err, i.e., the maximum error Errₘₐₓ of all frequency bands; judging Errₘₐₓ and an allowable error Err₀ of the full frequency band to preliminarily determine whether the number of interpolation points meets accuracy requirements; if Errₘₐₓ≤Err₀, finishing the sampling process; and if Errₘₐₓ>Err₀, increasing the number of interpolation points to meet the accuracy requirements;
(4) Solving a cross-spectral density matrix of an interpolation frequency point and a plurality of adjacent points according to the need of the interpolation function, performing Cholesky decomposition to solve a corresponding lower triangular matrix H, using the interpolation function to solve matrices Ĥ at other frequencies approximately, and finally generating a required fluctuating wind speed time series based on FFT.

The present invention has the following beneficial effects:
(1) The frequency sampling points selected by the isogeometric sampling method can adapt to the needs of different target wind spectra, and ensure that a better interpolation result can be obtained with fewer interpolation points, so as to give consideration to the simulation accuracy and computational efficiency of the harmonic superposition method.
(2) The isogeometric sampling method only needs one objective function to select sampling points, which has strong operability.
(3) The principle of the isogeometric sampling method comes from the concept of “uniform sampling” in the field of curve reconstruction. A uniform sampling method is mature in the field of CAD, and is an effective method for selecting frequency interpolation points.

### DESCRIPTION OF DRAWINGS

FIG. 1 is a flow chart of wind field simulation based on an isogeometric sampling method;

FIG. 2 is a structural diagram of a transmission tower-line system selected in an embodiment of the present invention;

FIG. 3 is a wind speed time series diagram of simulation point A in an embodiment of the present invention;

FIG. 4(a) is a power spectral density diagram of a simulated wind speed at point A in an embodiment of the present invention;

FIG. 4(b) is a cross-correlation function diagram of points A and B in an embodiment of the present invention.

### DETAILED DESCRIPTION

To make the purpose, features and advantages of the present invention more clear and legible, the technical solution in the embodiments of the present invention will be clearly and fully described below in combination with the drawings in the embodiments of the present invention. Apparently, the described embodiments are merely part of the embodiments of the present invention, not all of the embodiments. Based on the embodiments in the present invention, all other embodiments obtained by those ordinary skilled in the art without contributing creative labor will belong to the protection scope of the present invention.

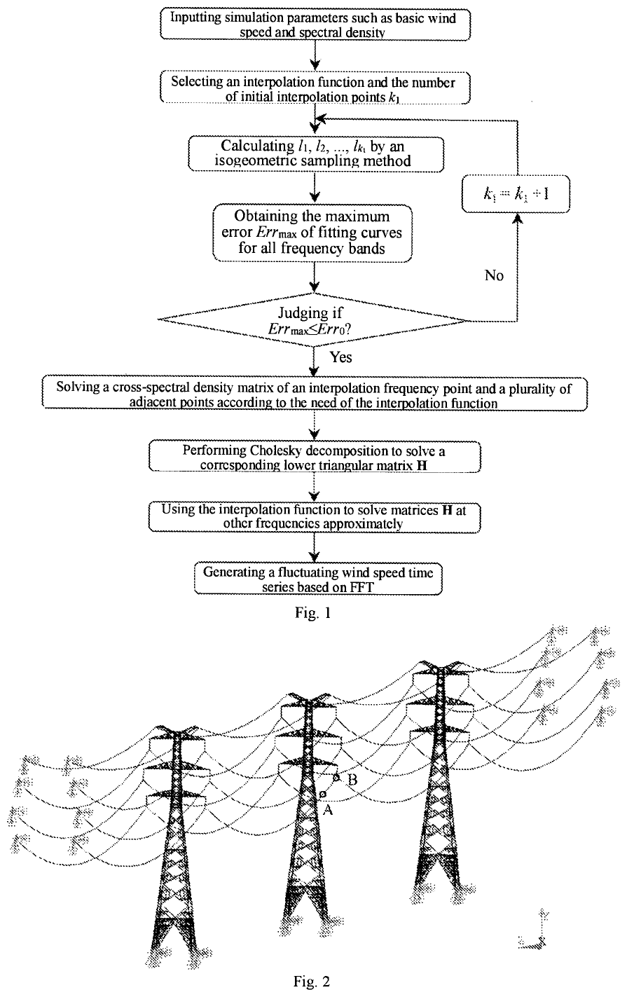

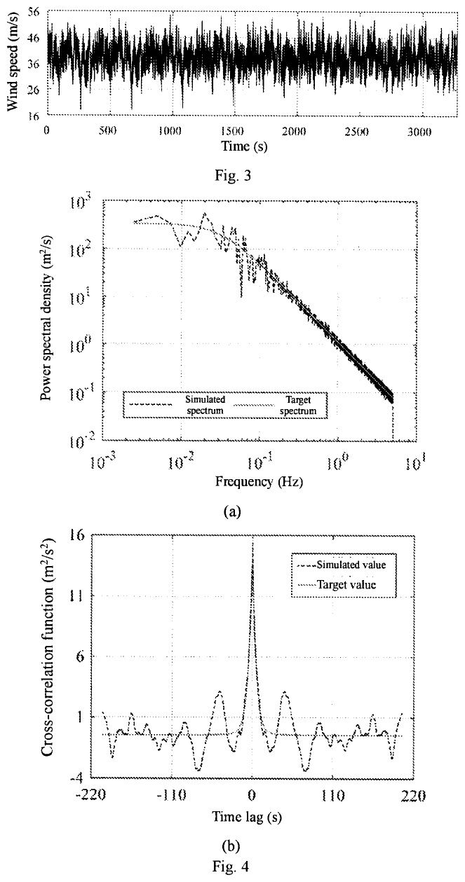

Referring to FIG. 1 to FIG. 4, embodiments of the present invention take 656 simulation points in space as an example to propose an efficient three-dimensional wind field simulation method.

For embodiment data source, please refer to “Fu X and L H N, Dynamic analysis of transmission tower-line system subjected to wind and rain loads, Journal of Wind Engineering and Industrial Aerodynamics, 2016, 157, 95-103”.

In an embodiment of the present invention, wind field simulation of the simulation points is generated by MATLAB software, which is specifically described with reference to the flow shown in FIG. 1 and the technical solution of the present invention:
(1) In the embodiment, three transmission towers with a height of 99.9 m are used. For details about the tower structure and transmission line, see the relevant presentation in Section 5 and Section 6 of “Fu X and Li H N, Dynamic analysis of transmission tower-line system subjected to wind and rain loads, Journal of Wind Engineering and Industrial Aerodynamics, 2016, 157, 95-103”.
(2) First, inputting basic parameters of wind field simulation such as power spectral density, surface roughness and basic wind speed into a MATLAB program. In the embodiment, a Karman wind spectrum and a Davenport coherence function model are used to simulate the spatial dependency of fluctuating wind; the attenuation coefficients of the coherence function in x, y and z directions are respectively 16, 6 and 10; an exponential law is used to simulate a mean wind profile; the surface roughness is Class B (i.e., α=0.15) of the Chinese specification “DL/T5551-2018. Load code for the design of overhead transmission line. National Energy Administration. 2018”; and the basic wind speed at a height of 10 m is 30 m/s.
(3) Taking the arithmetic square root \sqrt{S(n)} of a power spectral function as an objective function R(n) for fitting, i.e., R(n)=\sqrt{S(n)}, selecting geometric quantities such as an arc length and a curvature as a characteristic function λ(n) for sampling point selection according to the objective function, comprehensively considering the influence of the curvature and the arc length on shape, and defining the characteristic function R(n) of λ(n) as:

$$λ ( n ) = ( 1 - μ ) \frac{L ( n )}{L ( {n}_{b} )} + μ \frac{K ( n )}{K ( {n}_{b} )} , x ∈ [ {n}_{a} , {n}_{b} ] \qquad ( 5 )$$

where, a curvature weight is taken as μ=0.2 in the embodiment.

Inputting the number of sampling points k₁ (with the left and right endpoints removed), and calculating all λ(lΔn) according to a definite integral, wherein l is a variable with a value of 2, . . . , N−1. Obtaining the lᵢ^{th} frequency, i.e., obtaining the frequency nₖₗ, of a double-indexing interpolation point, as shown in formula (3):

$${l}_{i} = arg min \{ λ ( l Δ n ) - \frac{i}{{k}_{1} + 1} \} \qquad ( 6 )$$

$${n}_{{kl}_{i}} = ( {l}_{i} - 1 + \frac{k}{m} ) Δ n \qquad ( 7 )$$

(4) In the embodiment of the present invention, selecting a two cubic Hermite interpolation function as an interpolation function used for wind field simulation, selecting the form of the interpolation function used for wind field simulation, and measuring the simulation accuracy of a target curve in the form of a relative error, so as to estimate a wind field simulation error; defining a relative error of the interpolation function in the i^{th} band, as shown in formula (4):

$$err ( i ) = max \{ max \{ \frac{\vert {R}_{1} ( n ) - {\hat{R}}_{1} ( n ) \vert}{{R}_{1} ( n )} \} , max \{ \frac{\vert {R}_{2} ( n ) - {\hat{R}}_{2} ( n ) \vert}{{R}_{2} ( n )} \} \} ( {n}_{i} \leq n < {n}_{i + 1} ) \qquad ( 8 )$$

where, R₁(n) and R₂(n) respectively represent the arithmetic square roots of the power spectral function at the lowest and highest positions of all simulation points, \hat{R}₁(n) and \hat{R}₂(n) are respectively fitting functions of R₁(n) and R₂(n), and i=1, 2, . . . , k₁;
Recording the maximum value of vector err, i.e., the maximum error Errₘₐₓ of all frequency bands; judging Errₘₐₓ and an allowable error Err₀ of the full frequency band to preliminarily determine whether the number of interpolation points meets accuracy requirements; if Errₘₐₓ≤Err₀, finishing the sampling process; and if Errₘₐₓ>Err₀, increasing the number of interpolation points, i.e., letting k₁=k₁+1 and repeating the sampling process until the accuracy requirements are met.
(5) Solving a cross-spectral density matrix of an interpolation frequency point and adjacent frequency points, performing Cholesky decomposition to obtain a corresponding lower triangular matrix H, and using the interpolation function to solve the approximate lower triangular matrices Ĥ at other frequencies approximately. The Hermite interpolation function for an interval [nᵢ, nᵢ₊₁] is shown in formula (5):

\tilde{H}(n)=H(nᵢ)+H′(nᵢ)(n−nᵢ)+a₁(n−nᵢ)²+a₂(n−nᵢ)²(n−nᵢ₊₁) (9)

where, the matrix form and parameter matrices a₁ and a₂ for obtaining the approximate derivative of each element of H can be calculated according to formulae (6) to (8):

$${H}^{'} ( {n}_{i} ) = \frac{H ( {n}_{i} + Δ n ) - H ( {n}_{i} )}{Δ n} \qquad ( 10 )$$

$${a}_{1} = \frac{H ( {n}_{i + 1} ) - H ( {n}_{i} ) + {\overline{n}}_{i} {H}^{'} ( {n}_{i} )}{{\overline{n}}_{i}^{2}} \qquad ( 11 )$$

Using the interpolation function of formula (5) to solve approximate lower triangular matrices Ĥ at other frequencies approximately, obtaining all the elements of matrix H required, substituting the elements into a formula of a Deodatis double-indexing frequency simulation method, and then generating a fluctuating wind speed time series at each point based on FFT algorithm. A whole simulation process is shown in FIG. 1.

Attention shall be paid during the use of the present invention: in actual simulation, the curvature weight μ needs to be adjusted according to a wind spectrum function curve and selected as a real number between 0 and 1, so as to achieve a better simulation effect; the interpolation function is not limited to the Hermite interpolation function and is selected according to actual needs.

The above embodiments are only used for describing the technical solution of the present invention rather than limiting the same. Although the present invention is described in detail by referring to the above embodiments, those ordinary skilled in the art should understand that: the technical solution recorded in each of the above embodiments can be still amended, or some technical features therein can be replaced equivalently. However, these amendments or replacements do not enable the essence of the corresponding technical solutions to depart from the spirit and the scope of the technical solutions of various embodiments of the present invention.

1. A wind field interpolation simulation method based on isogeometric sampling, comprising the following steps:
(1) taking the arithmetic square root \sqrt{S(n)} of a power spectral function at the middle height of all simulation points as an objective function R(n) for fitting, i.e., R(n)=\sqrt{S(n)}, selecting an arc length and a curvature as a characteristic function λ(n) for sampling point selection according to the objective function, comprehensively considering the influence of the curvature and the arc length on shape, taking a curvature weight as μ, and defining the characteristic function λ(n) of R(n) as:
$$λ ( n ) = ( 1 - μ ) \frac{L ( n )}{L ( {n}_{b} )} + μ \frac{K ( n )}{K ( {n}_{b} )} \qquad ( 13 )$$
where, n is a frequency, satisfying n∈[nₐ, n_{b}], nₐ and n_{b} are respectively the left and right endpoints of the definition domain of the objective function R(n), i.e., the starting and ending frequencies of the target power spectral density for wind field simulation; μ is a real number between 0 and 1, which is adjusted according to the calculation result; L(n) and K(n) are respectively the arc length and total curvature from R(nₐ) to R(n), wherein
$$\begin{matrix}L ( n ) = {\int }_{{n}_{a}}^{n} \sqrt{1 + {( R ' ( u ) )}^{2}} du , & K ( n ) =\end{matrix} {\int }_{{n}_{a}}^{n} \frac{\vert R \text{''} ( u ) \vert}{{( 1 + {( R ' ( u ) )}^{2} )}^{\frac{3}{2}}} du ;$$
integrands of both integrals are greater than or equal to 0 and are not always 0, λ(n) is strictly monotonically increasing, λ(nₐ)=0, and λ(n_{b})=1;
(2) inputting the number of sampling points k₁, with the left and right endpoints removed from k₁; based on the characteristic function λ(n), selecting a frequency interpolation point nᵢ(i=1, 2, . . . , k₁), applying the frequency interpolation point to a double-indexing frequency simulation formula proposed by Deodatis, and calculating all λ(lΔn) according to a definite integral, wherein l is 2, 3, 4, . . . , N−1; obtaining the lᵢ^{th} frequency, i.e., obtaining the frequency of a double-indexing interpolation point, as shown in formulae (2) to (3):
$${l}_{i} = arg min \{ λ ( l Δ n ) - \frac{i}{{k}_{1} + 1} \} \qquad ( 14 )$$
$${n}_{{kl}_{i}} = ( {l}_{i} - 1 + \frac{k}{m} ) Δ n \qquad ( 15 )$$
where, arg min(⋅) is the value of the independent variable when the minimum value of “⋅” is taken, i.e., the value of l; m is the number of simulation points in a wind field,
$$Δ n = \frac{{n}_{u}}{N} , {n}_{u}$$
is the ending frequency of simulation, and N is a frequency isodisperse;
(3) selecting the form of an interpolation function used for wind field simulation, and measuring the simulation accuracy of a target curve in the form of a relative error, so as to estimate a wind field simulation error; defining a relative error of the interpolation function in the i^{th} band, as shown in formula (4):
$$err ( i ) = max \{ max \{ \frac{\vert {R}_{1} ( n ) - {\hat{R}}_{1} ( n ) \vert}{{R}_{1} ( n )} \} , max \{ \frac{\vert {R}_{2} ( n ) - {\hat{R}}_{2} ( n ) \vert}{{R}_{2} ( n )} \} \} ( {n}_{i} \leq n < {n}_{i + 1} ) \qquad ( 16 )$$
where, R₁(n) and R₂(n) respectively represent the arithmetic square roots of the power spectral function at the lowest and highest positions of all simulation points, \hat{R}₁(n) and \hat{R}₂(n) are respectively fitting functions of R₁(n) and R₂(n), and i=1, 2, . . . , k₁;
recording the maximum value of vector err, i.e., the maximum error Errₘₐₓ of all frequency bands; judging Errₘₐₓ and an allowable error Err₀ of the full frequency band to preliminarily determine whether the number of interpolation points meets accuracy requirements; if Errₘₐₓ≤Err₀, finishing the sampling process; and if Errₘₐₓ>Err₀, increasing the number of interpolation points to meet the accuracy requirements;
(4) solving a cross-spectral density matrix of an interpolation frequency point and a plurality of adjacent points according to the need of the interpolation function, performing Cholesky decomposition to solve a corresponding lower triangular matrix H, using the interpolation function to solve matrices Ĥ at other frequencies approximately, and finally generating a required fluctuating wind speed time series based on FFT.
